(19) United States
(12) Patent Application Publication
(10) Pub. No.: US 2008/0309076 A1
(43) Pub. Date: Dec. 18, 2008

(54) Device and Method for a Fluid-Tight Connection

(75) Inventor: Sylvain Cormier, Newmarket (CA)

Correspondence Address: WATERS INVESTMENTS LIMITED;C/O WATERS CORPORATION, 34 MAPLE STREET - LG, MILFORD, MA, 01757, US

(73) Assignee: WATERS INVESTMENTS LIMITED, New Castle, DE (US)

(21) Appl. No.: 11/816,295

(22) PCT Filed: Feb. 24, 2006
(86) PCT No.: PCT/US2006/006957

§ 371 Date: Apr. 10, 2008

Related U.S. Application Data
(60) Provisional application No. 60/656,242, filed on Feb. 25, 2005.

(51) Int. Cl. F16L 17/00

(52) U.S. Cl. 285/256

(57) ABSTRACT

A device for connecting a fluid conduit to an orifice of a vessel includes a flexible fitting, a deformable fitting, and one or more compression fittings. The flexible fitting can fix a position of the fluid conduit with respect to the orifice of the vessel, and the deformable fitting can provide a fluid seal between the fluid conduit and the orifice of the vessel. A method for connecting a fluid conduit to an orifice of a vessel includes urging a deformable fitting against both a surface of the fluid conduit and the orifice, urging a flexible fitting toward a surface of the fluid conduit, and attaching the flexible fitting to the orifice.

### CROSS REFERENCE RELATED APPLICATION INFORMATION

This application claims priority from U.S. Provisional Patent Application No. 60/656,242, filed Feb. 25, 2005. The contents of this application is incorporated herein by reference.

### TECHNICAL FIELD

The invention generally relates to connectors, and, more particularly, to high-pressure connectors for use in chromatography systems.

### BACKGROUND INFORMATION

Gas and liquid chromatography are processes used in analytical and preparative chemistry. Typically, a stationary porous material is held in a vessel, such as a column, while a sample compound in a carrier fluid passes through the porous material. In some cases, the stationary material is an inert powder coated with a stationary liquid agent.

Various distinct chemical compounds contained in a carrier fluid can have varying affinities for a stationary phase. Consequently, as the mobile fluid moves through a chromatographic column, various chemical compounds are delayed by varying times due to their interaction with the stationary phase. These various compounds emerge from the column at different times and are detected individually by, for example, a refractometer, an ultra-violet light detector or some other analytical apparatus in which the fluid flows upon leaving the chromatographic column.

Much of the effort directed to the development of chromatography has been devoted to the design of equipment that would tend to idealize the distribution and flow of a mobile phase through a porous stationary phase. Some work has been directed to the design of end fittings to connect components through which a fluid flows. Such connectors generally should be leak resistant and mechanically stable, and should optimize the initial distribution of a mobile liquid at the top of a column. Other work has related to avoidance of preferential flow of fluid between the walls of a column and a packing material.

Problems associated with the design and use of end fittings are particularly difficult when high pressure chromatography is used. Pressures in the range of, for example, 1,000 to 5,000 psi or higher can be used in liquid chromatography. Consequently, dependable sealing techniques should be used. Problems arise in, for example, assuring an adequate seal without excessive wear of deformed metal parts. For example, some fittings have ferrules which are tightened about a tube and/or column. After use, the shape of a tube or column can be distorted by the force exerted on the ferrule during tightening of end fittings.

One approach to closing a high-pressure column is the use of a compression screw and ferrule assembly. In such a device, the liquid seal between a liquid inlet pipe and the column is achieved by compressing a ferrule against both an inlet pipe and a port of the column to both seal and stabilize the pipe. Maintenance of a desired position of a pipe can be desirable to eliminate “dead volume” between the end of the pipe and the column, and to avoid pressing the pipe against the column with an undesirable force.

### SUMMARY OF THE INVENTION

The invention arises, in part, from the realization that one can decouple sealing and stabilizing forces involved in connections between fluid-carrying components, such as a tube and a vessel. By decoupling these forces, improved control can be obtained over a fluid-tight seal between components, and over the mechanical stability of the connected components.

In some embodiments of the invention, a connecting device includes a ferrule to provide a seal between a conduit and a vessel, a collet to secure the conduit relative to the vessel, and one or more members that apply mechanical forces to the ferrule and the collet. In some embodiments, a collet secures an outer axial surface of the conduit without pressing the conduit toward the vessel.

Various embodiments of the invention provide several advantages over some prior connecting devices. For example, some embodiments are smaller than prior connectors, and/or support operation at relatively high pressures, such as about 15 Kpsi and higher.

Accordingly, one embodiment of the invention features a device for connecting a fluid conduit to an orifice of a vessel. The device includes a flexible fitting, a deformable fitting, and one or more compression fittings. The flexible fitting can fix a position of the fluid conduit with respect to the orifice of the vessel. The deformable fitting can provide a suitable fluid seal between the fluid conduit and the orifice of the vessel. The compression fitting(s) can urge the flexible fitting toward a surface of the fluid conduit to secure the conduit without pressing the conduit towards and/or against the orifice. At least one of the compression fitting(s) urges the deformable fitting toward both a surface of the conduit and the orifice.

A second embodiment of the invention features a method for connecting a fluid conduit to an orifice of a vessel. The method includes urging a deformable fitting against both a surface of the fluid conduit and the orifice, urging a flexible fitting toward a surface of the fluid conduit, and attaching the flexible fitting to the orifice.

The deformable fitting, such as a polymeric ferrule, can provide a substantially fluid-tight seal between the fluid conduit and the orifice. The flexible fitting can fix a position of the fluid conduit relative to a position of the flexible fitting. The flexible fitting can be attached directly or indirectly to the orifice. For example, a compression fitting can both press the flexible fitting against the conduit, and can be attached to the orifice, for example, via mating of threaded surfaces.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1a is a cutaway diagram illustrating a device, in accordance with one embodiment of the invention;

FIG. 1b is a three-dimensional illustration of the device of FIG. 1a;

FIG. 2a is a three-dimensional view of a collet, associated with the device of FIG. 1a;

FIG. 2b is a lateral cross-sectional view of a collet associated with FIG. 2a;

FIG. 2c is a longitudinal cross-sectional view of the collet of FIG. 2b;

FIG. 3a is a three-dimensional view of a compression fitting associated with FIG. 2a;

FIG. 3b is an end view of the compression fitting of FIG. 3a;

FIG. 3c is a longitudinal cross-sectional view of the compression fitting of FIG. 3a;

FIGS. 4a and 4b are three-dimensional illustrations of an integrated component of a device, in accordance with one embodiment of the invention;

FIG. 4c is an end view of the integrated component of FIG. 4a;

FIG. 4d is a longitudinal cross-sectional view of the integrated component of FIG. 4a;

FIG. 4e is a three-dimensional illustration of a second compression fitting associated with the component of FIG. 4a;

FIGS. 5a and 5b are three-dimensional illustrations of a compression fitting of a device, in accordance with one embodiment of the invention;

FIG. 5c is an end view of the compression fitting of FIG. 5a;

FIG. 5d is a longitudinal cross-sectional view of the compression fitting of FIG. 5a;

FIGS. 5e and 5f are three-dimensional views of a collet associated with the compression fitting of FIG. 5a;

FIG. 5g is an end view of the collet of FIG. 5e;

FIG. 5h is a longitudinal cross-sectional view of the collet of FIG. 5e; and

FIG. 6 is a three-dimensional illustration of a device, in accordance with one embodiment of the invention.

### DESCRIPTION

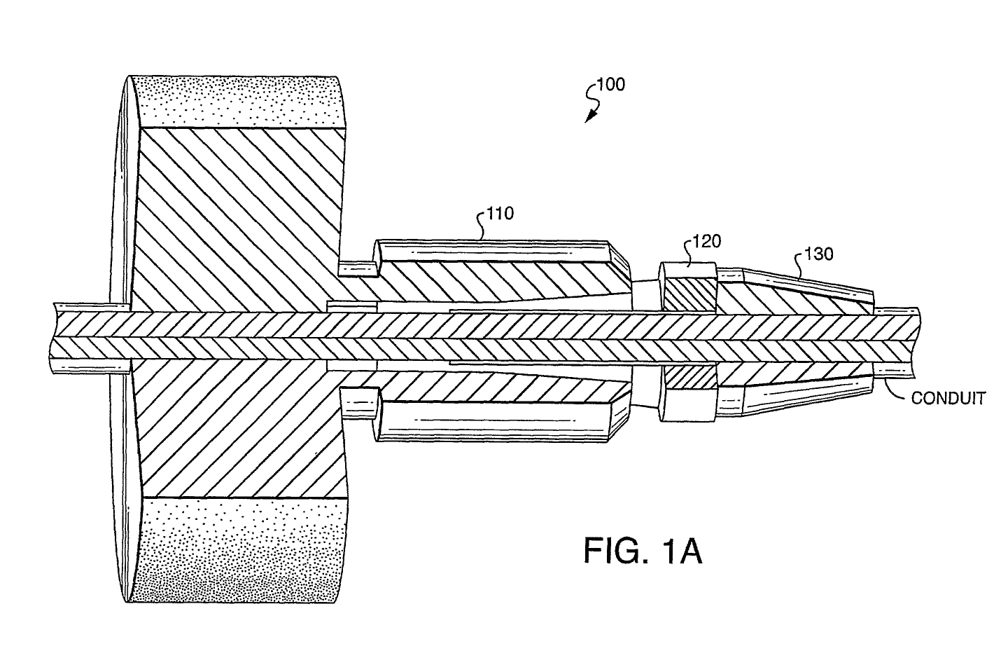

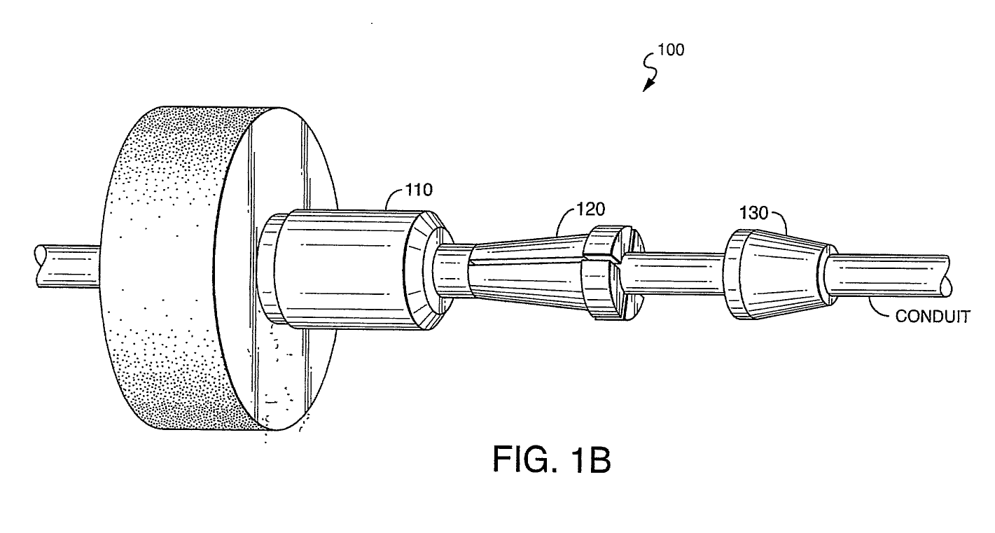

FIG. 1a is a cutaway diagram illustrating a connecting device 100, in accordance with one embodiment of the invention. The device 100 includes a compression fitting 110, a flexible fitting 120, and a deformable fitting 130. The device 100 can be used to connect components that support the flow of a fluid, such as a liquid or gas. The fluid can include a mixture of material. The device 100 can be used, for example, to connect a conduit, such as a tube, to a vessel, such as a column, used in an analytical instrument. The instrument is, for example, a chromatographic system.

For convenience of description, the flexible fitting 120 will be referred to herein as a “collet” and the deformable fitting will be referred to herein as a “ferrule”. It should be understood, however, that use of these terms is not intended to limit embodiments of the invention to devices that include collet(s) and/or ferrule(s). Moreover, although the embodiments described herein include fittings that completely surround a conduit and have portions that form a continuous ring disposed around a conduit, alternative embodiments can include fittings that partially surround a conduit and/or only surround a conduit with a discontinuous ring.

The components 110, 120, 130 of the device 100 are configured so that the compression fitting 110 can compress a portion of the collet 120 against an axially aligned outer surface of the tube, and simultaneously can compress the ferrule 130 against the tube and the vessel. The compression fitting 110 applies a force to the ferrule 130 via the collet 120 acting as in intermediary.

The components 110, 120, 130 can be fabricated from any suitable materials. For example the ferrule 130 includes any suitably deformable material, such as a polymer, including suitable polymers known to one having ordinary skill in the connector arts. The collet 120 includes any suitably flexible material, such as a hard polymer and/or a metal, such as a steel. The compression fitting 110 is formed of material(s) suitable for, for example, compression screws, as known to one having ordinary skill in the connector arts, or other suitable materials. Some suitable materials include metals, such as steel or other alloys, polymers, and/or ceramic materials. The components optionally include, for example, mixtures and/or layers of materials, and/or coatings.

The ferrule 130 provides a seal between the tube and the vessel to prevent fluid leakage up to suitably high pressures. By finger tightening the compression fitting, with a torque of, for example, about 50 to about 80 inch-ounces, a leak resistance of about 15 Kpsi to 20 Kpsi is obtainable.

The ferrule 130 can be sealed with a force of, for example, 20 lbs. According to some principles of the invention, additional force need not be applied to the ferrule to secure the position of the tube. Thus, damage to the device 100, the tube, and/or the vessel can be avoided, and the device can be repeatedly used and disassembled.

Unlike some prior connectors, the ferrule 130 need not secure the position of the tube relative to the vessel. For this purpose, the collet 120 secures the position of the tube via the holding force applied with pressure derived from the compressive fitting 110. The collet 120, in turn, is indirectly attached to the vessel via a direct contact made by the compressive fitting.

FIG. 1b is a three-dimensional view of the device 100, with the components 110, 120, 130 shown prior to assembly (or after disassembly.) The components 110, 120, 130, in this illustration, are positioned on a tube prior to connecting the tube to a vessel (or after disconnecting the tube from the vessel.)

In view of the description contained herein, alternative implementations of devices that incorporate features of the invention will be apparent to one having ordinary skill in the fluidic-connector arts. For example, in one alternative embodiment similar to the device 100, a fitting, similar to the fitting 110, has a threaded outer surface that is configured to mate with a threaded inner surface of an orifice of a vessel. A collet, such as the collet 120, is formed of stainless steel, and a ferrule, such as the ferrule 130, is formed of a polymer. Suitable forces can be applied to the stainless steel collet and the polymeric ferrule by finger tightening the compression screw into the orifice of the vessel.

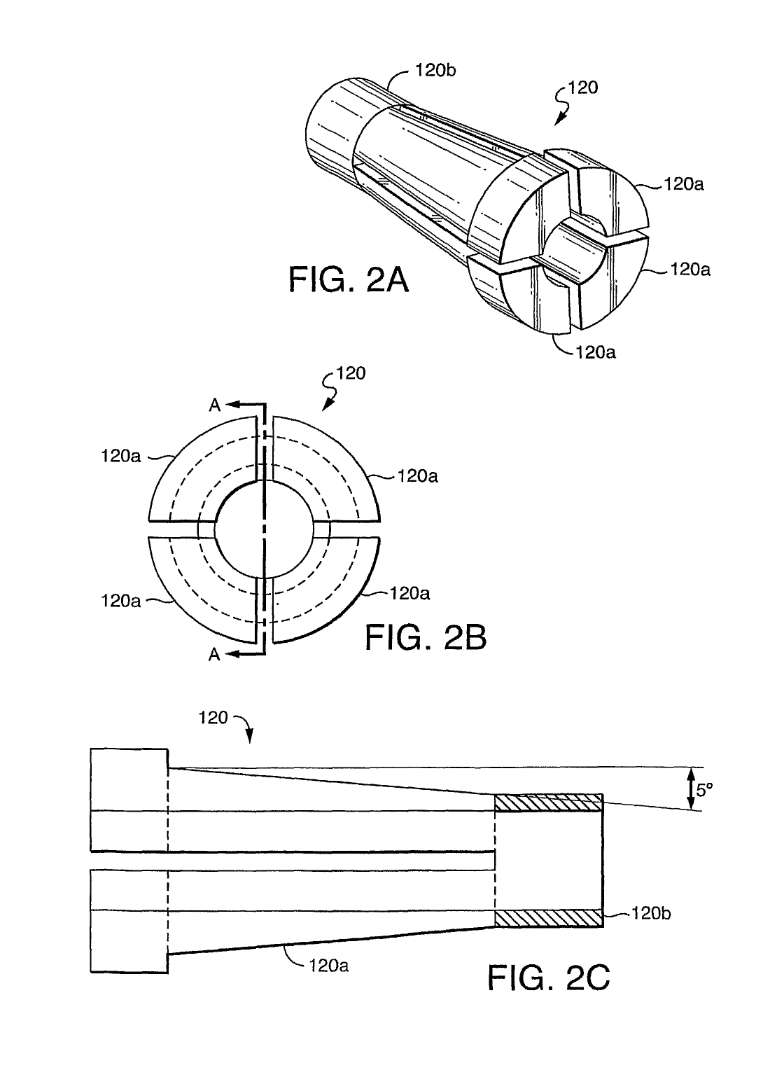

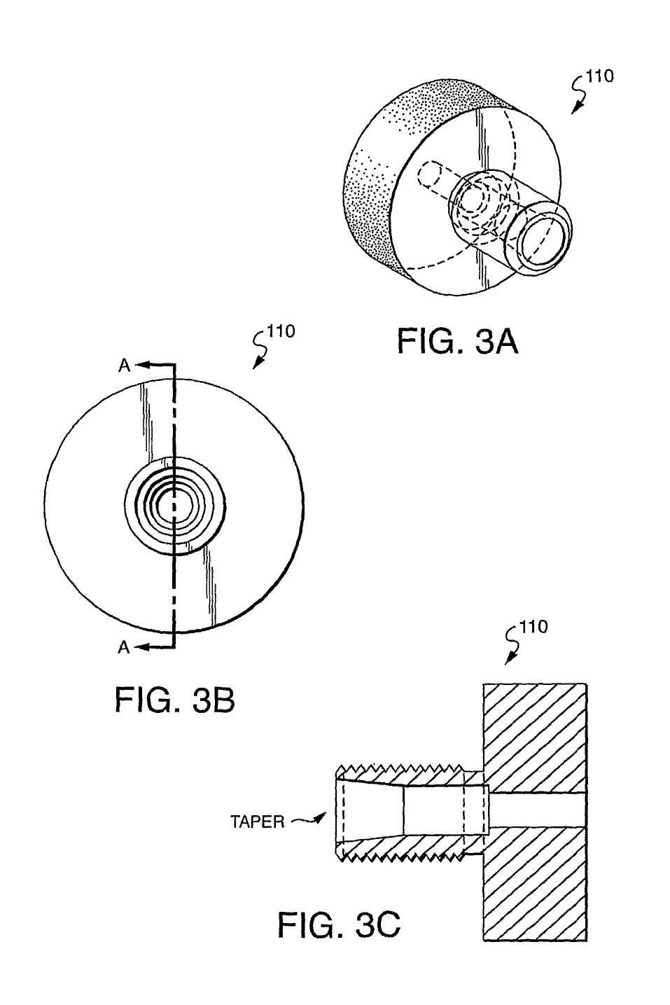

Referring next to FIGS. 2a, 2b, 2c, 3a, 3b, and 3c, the device 100 is described in more detail. FIG. 2a is a three-dimensional diagram of the collet 120, FIG. 2b is a lateral cross-section diagram of the collet 120, and FIG. 2c is a longitudinal cross-section diagram of the collet 120 through section “A” as indicated in FIG. 2b. The collet 120 includes four fingers 120a and a band 120b from which the fingers 120a extend in a longitudinal (axial) direction. The fingers 120a have a tapered outer surface, which, as described below, are configured to mate with an inner surface of the compression fitting 110.

It will be apparent, in view of the description herein, that alternative embodiments of the invention can include collets having fewer or more than four fingers, or alternative configurations that provide sufficient flexibility to permit pressing the collet against a tube.

FIG. 3a is a three-dimensional diagram of the compression fitting 110, FIG. 3b is an end-view diagram of the compression fitting 110, and FIG. 3c is a longitudinal cross-section diagram of the compression fitting 110 through section A as indicated in FIG. 3b.

The compression fitting 110 has a threaded portion, and a knurled portion to assist finger tightening the threaded portion into a threaded orifice of a vessel. The threaded portion of the compression fitting 110 has an inner surface for receiving and applying a force on the collet 120. The threaded portion has threads on an outer surface, which are configured to mate with threads on an inner surface of the orifice of the vessel.

The inner surface of the compression fitting 110 has a tapered portion, which permits gradual application of a force to the fingers 120a of the collet 120 as the compression fitting 110 is threaded into the orifice of the vessel. A taper angle associated with the tapered portion can be selected to support application of a suitable force on the fingers 120a of the collet 120 while also applying a suitable force, via the collet 120, on the ferrule 130. An example of a suitable taper angle is 5 degrees, as illustrated.

In view of the description herein, it will be apparent that dimensions and angles can be selected to provide a desired securing force on a collet 120 and a desired sealing force on a ferrule 130. Dimension can be chosen, at least in part, for example, to accommodate dimensions of a tube and a vessel orifice. For example, the fitting 110 and collet 120 can each define an interior passageway (a through hole) for insertion of a tube.

A narrowest diameter of a passageway can be selected to accommodate an outer diameter of a tube, which can be, for example, about 0.06 inch. Overall dimensions of the device 100 can be, for example, less than an inch. In addition to other advantages, the device 100 can more readily accommodate reduction of the space consumed by connecting devices than can some prior connecting device.

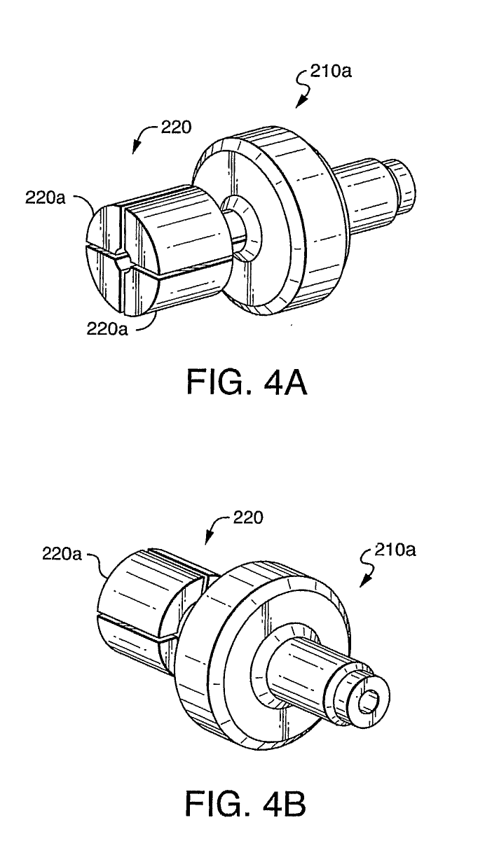

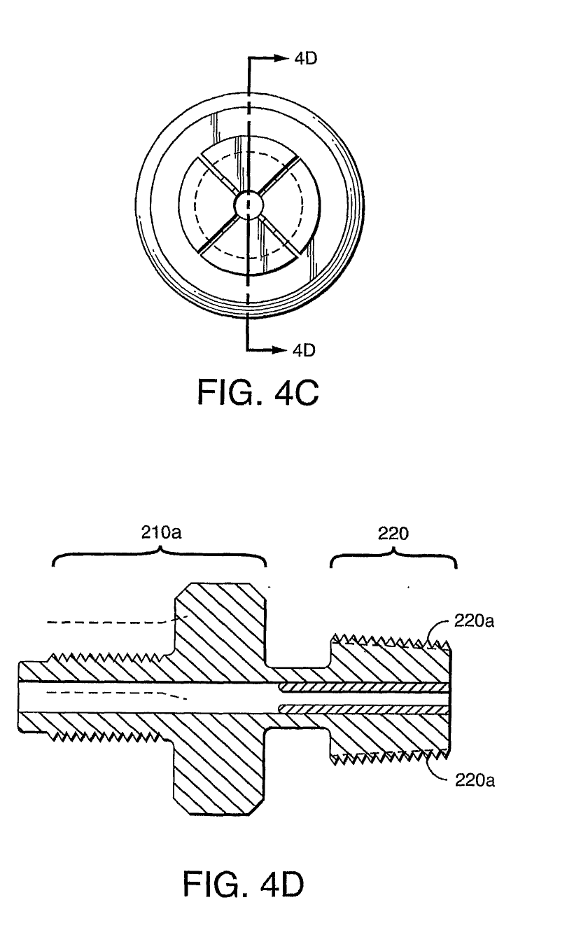

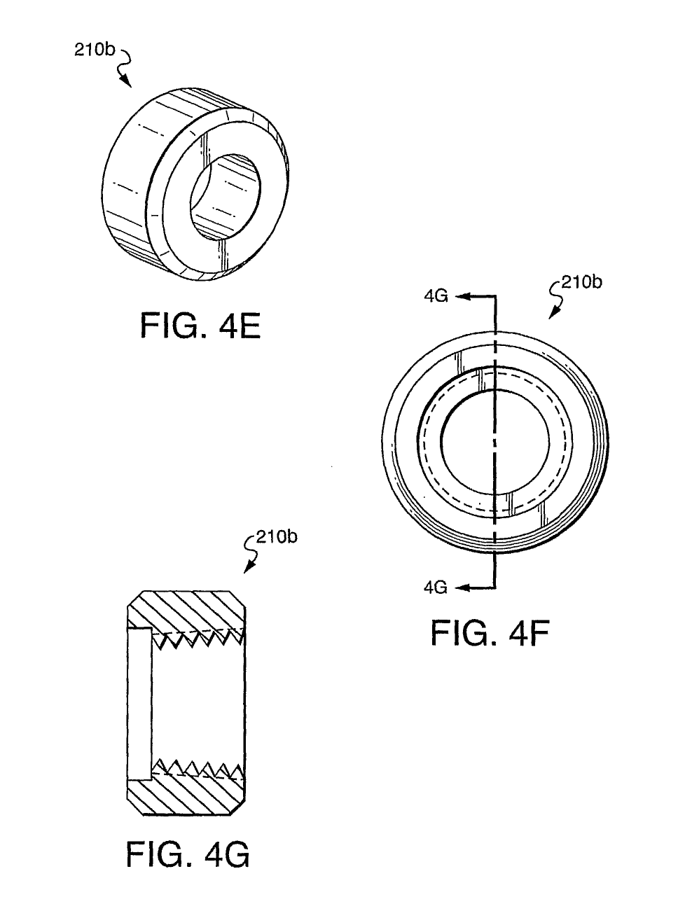

Next referring to FIGS. 4a, 4b, 4c, 4d, 4e, 4f, and 4g, another illustrative example of a device for connecting is described. The device includes first and second compression fittings 210a, 210b, a collet portion 220 having fingers 220a, and a ferrule (not shown). Optionally, as illustrated, the first compression fitting 210a is integrally attached to the collet portion 220.

FIGS. 4a, 4b, and 4c are three-dimensional illustrations of the integrated component, which includes both the first compression fitting 210a and the collet portion 220. The integrated component can be formed from a single piece of material, for example, by machining a single blank of stainless steel.

FIG. 4c illustrates an end view of the integrated component, viewed from a distal end. The distal end presses against a ferrule of the device when the first compression fitting 210a is attached to a vessel.

FIG. 4d illustrates a longitudinal cross section of the integrated component, with the location of the cross section indicated in FIG. 4c. An outer surface of the first compression fitting 210a has a threaded surface that mates with a threaded surface of an orifice of the vessel. An outer surface of the collet portion 220 is threaded and tapered to mate with the second compression fitting 210b as described below.

The first compression fitting 210a has a knurled surface for grasping to permit finger tightening of the compression fitting 210a in, for example, an orifice of the vessel. The compression fitting 210a can be tightened against the ferrule to provide a desired level of force applied to the ferrule. A desired level of force can provide leak resistance up to a particular level of fluid pressure.

FIGS. 4e, 4f, and 4g are, respectively, a three-dimensional view, an end view, and a cross-section view of the second compression fitting 210b. The second compression fitting 210b has an inner tapered threaded surface, which mates to the collet portion 220. The tapered surfaces provide an increasing level of force against the fingers 220a of the collet portion 220 as the second compression fitting 210b is threaded onto the collet portion 220.

The compression fitting 110 can be formed of, for example, a metal, such as stainless steel. The threads of the fitting 110 can be plated with gold, having a thickness, for example, of 0.00003 inch to act as a lubricant.

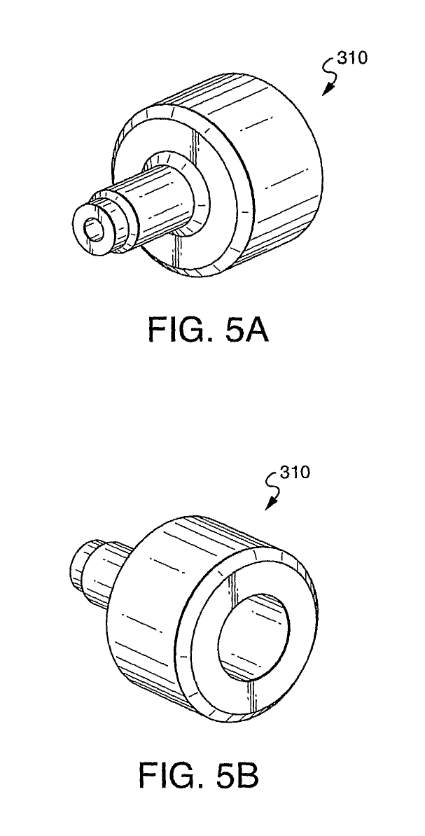

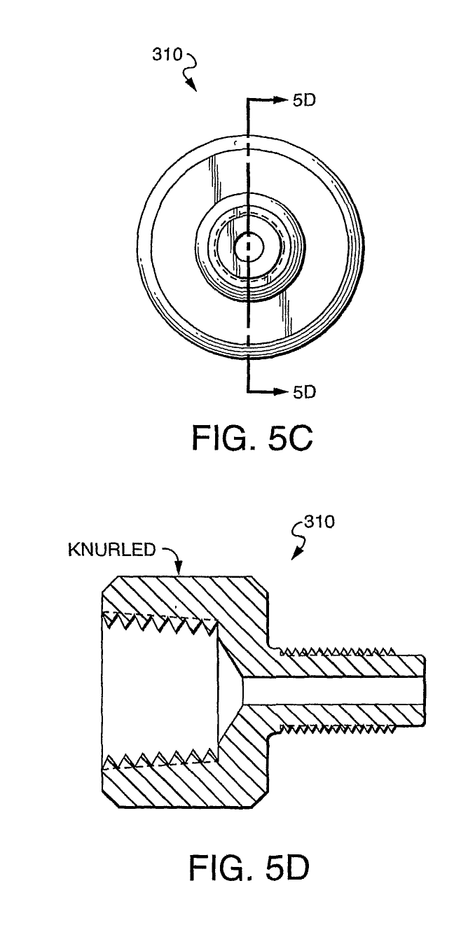

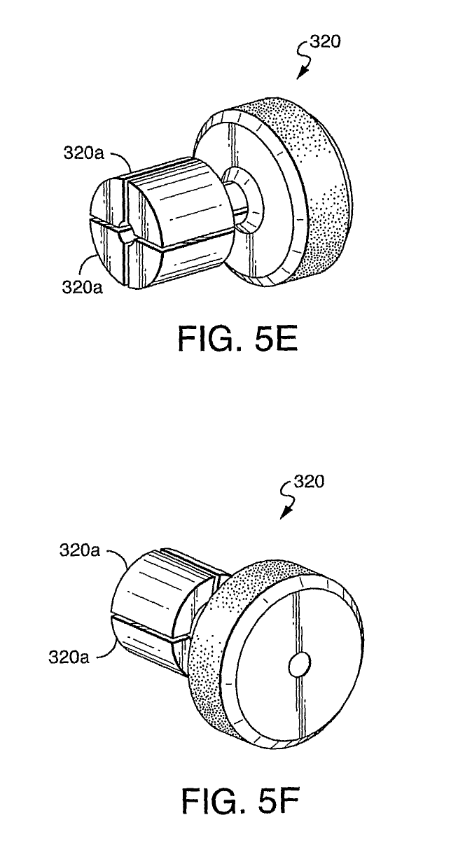

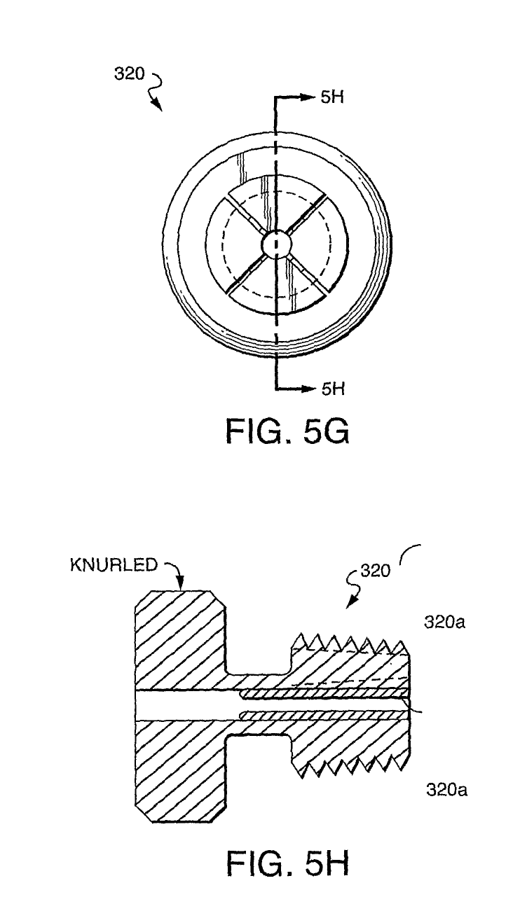

Next referring to FIGS. 5a, 5b, 5c, 5d, 5e, 5f, and 5g, another illustrative example of a device for connecting is described. The device includes a compression fitting 310, a collet 320 having fingers 320a, and a ferrule (not shown).

FIGS. 5a and 5b are three-dimensional illustrations of the compression fitting 310, FIG. 5c is an end-view illustration of the compression fitting 310, and FIG. 5d is a longitudinal cross-section diagram, taken along the section indicated in FIG. 5c. A distal end of the fitting 310 presses against the ferrule of the device when the compression fitting 310 is attached to a vessel.

The compression fitting 310 has a threaded outer surface, which can mate to an inner threaded surface of an orifice of a vessel. The compression fitting 310 has a knurled outer surface for grasping and turning to permit finger tightening of the compression fitting 310 in the orifice of the vessel. The compression fitting 310 can be tightened against the ferrule to provide a desired level of force application on the ferrule. A desired level of force can provide leak resistance up to a selected level of fluid pressure.

The compression fitting 310 also has a threaded and tapered inner surface, which mates with a tapered threaded surface of the collet 320, as described below.

FIGS. 5e and 5f are three-dimensional diagrams of the collet 320, FIG. 5g is an end-view diagram of the collet 320, and FIG. 5h is a longitudinal cross-section diagram, taken along the section indicated in FIG. 5g. The collet 320 has an outer tapered threaded surface, which mates to the compression fitting 310. The collet 320 also has a knurled outer surface for grasping and threading the collet 320 into the compression fitting 310.

Thus, in one method of assembly of this illustrative embodiment, the compression fitting 310 is first screwed into an orifice of a vessel to press against the ferrule to provide a suitable fluid tight seal between a tube and the vessel. Next, the fingers 320a of the collet 320 are screwed into the compression fitting 320 to secure the tube to the vessel. As described above, tapered surfaces provide a level of force that increases as the components 310, 320 are screwed together.

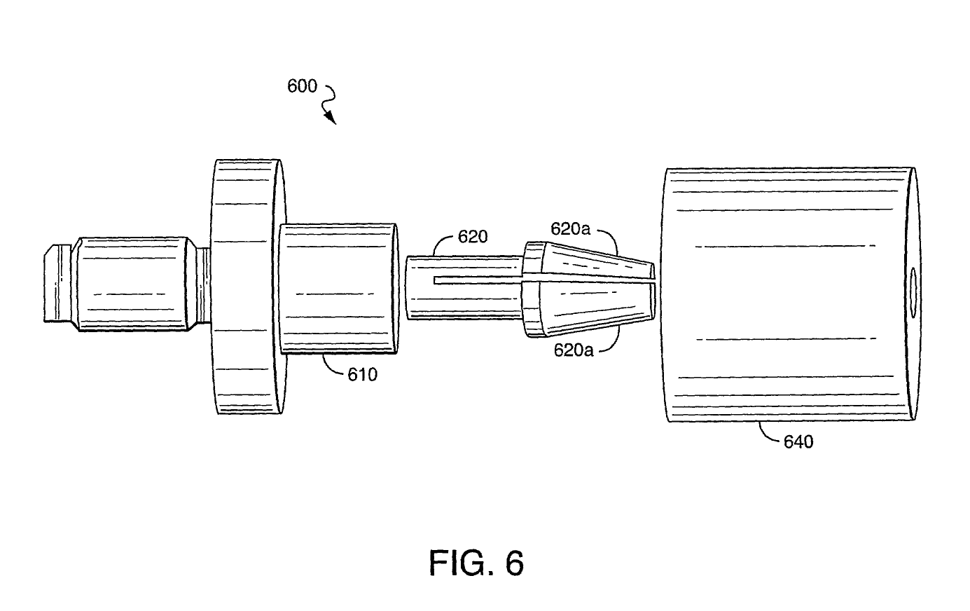

FIG. 6 is a three-dimension illustration of a portion of a connecting device 600, in accordance with one embodiment of the invention. The device 600 includes a first compression fitting 610, a second compression fitting 640, a flexible fitting 620, and a deformable fitting (not shown) such as the deformable fitting 130 illustrated in FIG. 1a.

The device 600 is used to connect components that support the flow of a fluid, such as a liquid or gas. The device 600 is used, for example, to connect a conduit, such as a tube, to a vessel, such as a column, used in an analytical instrument. The instrument is, for example, a chromatographic system.

The flexible fitting 620 is slidably disposed on a conduit to, for example, accommodate different conduit depths. Similar to the device 100 illustrated in FIG. 1a, the deformable fitting optionally provides a substantially fluid-tight seal between the fluid conduit and an orifice of a vessel.

The first compression fitting 610 urges the flexible fitting 620 toward an outer surface of the fluid conduit to substantially fix the position of the fluid conduit. The first compression fitting 610 and/or the flexible fitting 620 press the second compression fitting 640 against the deformable fitting to urge the deformable fitting toward both the outer surface of the conduit and the orifice.

Optionally, the first compression fitting 610 threadably attaches to the second compression fitting 640.

Variations, modifications, and other implementations of what is described herein will occur to those of ordinary skill in the art without departing from the spirit and the scope of the invention as claimed. Accordingly, the invention is to be defined not by the preceding illustrative description but instead by the spirit and scope of the following claims.

What is claimed is:

1. A device for connecting a fluid conduit to an orifice of a vessel, comprising:
a flexible fitting for substantially fixing a position of the fluid conduit with respect to the orifice of the vessel;
a deformable fitting for providing a substantially fluid-tight seal between the fluid conduit and the orifice of the vessel; and
at least one compression fitting for urging the flexible fitting toward an outer surface of the fluid conduit to substantially fix the position of the fluid conduit, and for urging the deformable fitting toward both the outer surface and the orifice.

2. The device of claim 1, wherein the flexible fitting comprises a plurality of fingers defining an axial passage for receiving the fluid conduit.

3. The device of claim 2, wherein the plurality of flexible fingers define a tapered outer surface.

4. The device of claim 3, wherein the at least one compression fitting defines a tapered inner surface that urges the fingers toward the outer surface of the fluid conduit by applying a pressure to the outer surface of the plurality of flexible fingers.

5. The device of claim 4, wherein inner surface of the compression fitting and the outer surface of the plurality of fingers are threaded.

6. The device of claim 2, wherein the flexible fitting further comprises a band from which the plurality of fingers axially extend, the band defining the axial passage in cooperation with the plurality of fingers.

7. The device of claim 1, wherein the flexible fitting comprises a collet.

8. The device of claim 1, wherein the flexible fitting comprises stainless steel.

9. The device of claim 1, wherein the at least one compression fitting consists of a single fitting that directly contacts the flexible fitting.

10. The device of claim 9, wherein the flexible fitting directly contacts the deformable fitting, and is urged against the deformable fitting by the single fitting.

11. The device of claim 1, wherein the at least one compression fitting comprises a first compression fitting for urging the flexible fitting toward the outer surface of the fluid conduit, and a second compression fitting for urging the deformable fitting toward both the outer surface and the orifice.

12. The device of claim 11, wherein the first compression fitting is disposed between the deformable fitting and the flexible fitting.

13. The device of claim 11, wherein the first compression fitting is fixedly attached to the flexible fitting.

14. The device of claim 13, wherein the first compression fitting and the flexible fitting are formed from a single piece of a metallic material.

15. The device of claim 9, wherein at least a portion of the single fitting is disposed between the flexible fitting and the deformable fitting.

16. The device of claim 15, wherein the single fitting is in direct contact with the deformable fitting.

17. The device of claim 15, wherein the flexible fitting is threadably attached to the single fitting, and the flexible fitting applies substantially no force to the deformable fitting.

18. The device of claim 1, wherein the deformable fitting comprises a ferrule.

19. The device of claim 1, wherein the deformable fitting comprises a polymer.

20. The device of claim 1, wherein the vessel comprises a chromatography column.

21. The device of claim 1, wherein the fluid conduit comprises a tube.

22. A device for connecting a fluid conduit to an orifice of a vessel, comprising:
a slidable flexible fitting for substantially fixing a position of the fluid conduit with respect to the orifice of the vessel;
a deformable fitting for providing a substantially fluid-tight seal between the fluid conduit and the orifice of the vessel;
a first compression fitting for urging the flexible fitting toward an outer surface of the fluid conduit to substantially fix the position of the fluid conduit; and
a second compression fitting for urging the deformable fitting toward both the outer surface and the orifice.

23. The method of claim 22, wherein the first compression fitting is configured for threadable attachment to the second compression fitting.

24. A method for connecting a fluid conduit to an orifice of a vessel, comprising:
urging a deformable fitting against both a surface of the fluid conduit and the orifice to provide a substantially fluid-tight seal between the fluid conduit and the orifice;
urging a flexible fitting toward a surface of the fluid conduit to substantially fix a position of the fluid conduit relative to a position of the flexible fitting; and
attaching, directly or indirectly, the flexible fitting to the orifice to substantially fix the position of the flexible fitting relative to a position of the orifice.

25. The method of claim 24, wherein urging the flexible fitting comprises threadably attaching a compression fitting to the flexible fitting.

26. The method of claim 24, wherein the surface of the fluid conduit is an exterior surface having a orientation substantially parallel to an axis defined by a lumen of the fluid conduit.

27. The method of claim 24, wherein urging the deformable fitting comprises applying a force of less than about 20 lbs to the deformable fitting.

28. The method of claim 24, where the substantially fluid-tight seal is resistant to a pressure of at least about 18 Kpsi.
